(19) United States
(12) Patent Application Publication
(10) Pub. No.: US 2025/0080547 A1
(43) Pub. Date: Mar. 6, 2025

(54) Information Security AI-Based Border Endpoint Zero-Day Block

(71) Applicant: Bank of America Corporation, Charlotte, NC (US)

(72) Inventors: Steven Sinks, Scottsdale, AZ (US); Jonathan Sheedy, Poynton (GB); Joshua Abraham, Sharon, MA (US)

(21) Appl. No.: 18/240,099

(22) Filed: Aug. 30, 2023

(51) Int. Cl. H04L 9/40

(52) U.S. Cl. CPC H04L 63/1416; H04L 63/0245; H04L 63/10; H04L 63/1433; H04L 63/1441; H04L 2463/146

(57) ABSTRACT

A real-time, information-security, border-endpoint system and process to block a zero-day threat is disclosed. Data, traffic, patterns, and payloads for incoming and outgoing border control devices (or edge devices) delineating protected from unprotected areas of a network, or close to the border of such, can be monitored, analyzed, compared, and processed by artificial intelligence (AI), which can be used to identify suspect traffic based on differences between the two and historical information compiled from prior Advanced Persistent Threats. Mitigation, countermeasures, reporting, quarantining, blocking, patching, and other features are disclosed as well.

### TECHNICAL FIELD

The present disclosure relates to access control in the field of information security and, more particularly, to systems, methods, and apparatus for preventing unauthorized access to resources of systems or information systems including the manner of identifying and verifying the entity, process, or mechanism requesting access to the resource, based on analysis and comparison of in-going and outgoing network packet traffic, traffic patterns, data, payloads, etc. observed with respect to inputs and outputs to network border control devices delineating protected from unprotected zones are monitored, filtered, analyzed, controlled, etc. by artificial intelligence (AI)/machine learning (ML) analyzer, network monitors, etc. that can be utilized to implement border endpoint zero-day blocks as needed.

### DESCRIPTION OF THE RELATED ART

Actors that pose an advanced persistent threat (APT) are highly competent and motivated to use complex ways in order to acquire access to the systems and data of a target. APT actors are frequently state-sponsored and target, among other things, the United States government, companies, research institutions, and educational institutions. They also have the resources and expertise to carry out long-term, targeted attacks that present clear and present dangers as well as unacceptable national security risks, provide opportunities for corporate espionage and the theft of intellectual property, misappropriate highly confidential information, inject malware, and engage in other malicious activities. This is especially problematic with regard to network edges, which are architectural demarcation points that can either be physical or virtual and are used to indicate sites where a secure network links to the Internet or to networks belonging to third parties.

As a point of reference, an edge device is a piece of hardware that functions as an entrance point into the main networks of businesses or service providers. Multiplexers, integrated access devices (IADs), routers, routing switches, and other forms of metropolitan area network (MAN) and wide area network (WAN) access devices are some examples. Additionally, edge devices offer connectivity into the networks of carriers and other service providers. An edge concentrator is a device that links a local area network to a high-speed switch or backbone (such an ATM switch), and the term is sometimes used to refer to this type of edge device.

In general, edge devices are typically routers that offer authorized access (PPPoA and PPPoE are the two protocols that are used the most) to backbone and core networks that are faster and more efficient. Because edge devices are comparatively “dumb and fast” compared to other higher end and costly protection systems, network borders and edge devices present increased security risks that are targeted by APT actors due to the manner in which APT threats are utilized and disseminated in the environment.

APT attacks, in general, can cause a great deal of disruption and often consist of a few different stages. First, the APT actor can collect information about the target during the reconnaissance phase. This information can include details about the target's networks, systems, and security measures. Second, when it comes to exploitation, the APT actor can make use of this information in order to get access to the target's systems by exploiting vulnerabilities (both known and undiscovered) in those systems. This can be accomplished by exploiting flaws in those systems. Third, lateral mobility allows the APT actor, once they have access, to travel laterally within the target's network in order to get access to additional sensitive data. This can be accomplished once they have gained access. A fourth phase may consist of the APT actor collecting data about the target, such as the target's intellectual property, confidential materials, design information, security details, financial information, non-public information, proprietary data, future plans or projects, customer data, or other information of similar nature.

Zero-day vulnerabilities are unpatched software security flaws that are unknown or known only to the vendor or developer of the software and can dramatically increase the risks posed by APT attacks to unsuspecting customers, companies, governments, or entities. As a result, hackers can take advantage of the vulnerability to gain unauthorized access to systems, network, edge devices, or edge border controls since there is no patch available to remedy the vulnerability. Because they can be used to compromise systems before the threat is detected or a patch is made available by the software vendor and timely notified for immediate remedy, zero-day vulnerabilities pose tremendous and unacceptable security risks. APT actors are presented with a window of opportunity to attack networks without worrying about being discovered.

APT actors have recently been finding new ways to compromise network border controls such as firewalls, various types of routers, cloud interfaces, gateways, VPNs, and other devices in order to get around preexisting security mechanisms by exploiting zero-day vulnerabilities. This is done in order to circumvent existing security mechanisms. This is especially true with Internet of Things (IoT) devices or other “dumb” devices, which may have a variety of services turned on but are unable to run antivirus software, an intrusion prevention system, an intrusion detection system, or other similar software. Therefore, instead of having to compromise every server on a network, an advanced persistent threat only has to compromise a border firewall or something similar. Once this has been accomplished, all of the traffic entering and exiting a company's firewall can now be watched and collected. Even if the traffic cannot be understood immediately, APT actors can transfer the encrypted traffic to a place of their choosing and then decode the traffic whenever it is convenient for them to do so.

This is also the case with respect to technologies such as firewalls, which many users may mistakenly believe are intelligent gadgets that are providing full protection. This is not correct. Because all they do is follow a predetermined sequence of procedures, firewalls are considered to be very “simple” devices. A firewall may first determine where incoming traffic is coming from, and only block it if the traffic is coming from an IP address that is restricted. It is also able to check from what port the traffic is arriving and determine what port the traffic will be heading to. In the event that access is granted to those ports, the firewall will be able to go on to the subsequent step on its list. The firewall's sole function is to iteratively work its way down a list in reverse order until it reaches the end of the list. If everything on the list is completed successfully, then the traffic may be permitted.

Current network border controls, due to limitations in their functionality and processing capability, do not have robust operating systems or advanced threat monitoring and protection systems, let alone AI/ML processing and learning capabilities, that would otherwise allow for host-based monitoring/alerting, historical learning, advanced threat protection, sufficient endpoint security, or the capacity to detect and implement zero-day blocking in real time by use of. By compromising these border systems an APT stays hidden, is able to siphon off data from these systems on in piecemeal or in bulk, and thereafter decrypt offsite any encrypted or retrieve data, traffic, or pack information in whatever time frame they want, and thereafter gain access to highly secretive information without ever alerting the company or any defensive controls in place to monitor a company's network. Worse yet, the data may be surreptitiously stored and then batch downloaded without warning over the Internet—without warning or the ability to retrieve the information—thereby allowing decryption and analysis by the APT at their convenience since control over and access to the protected information has been lost.

Due to the limited processing capabilities of border protection devices, businesses have limited options for protecting themselves from an APT. These include implementing measures such as using up-to-date security software whenever it becomes known, implementing generic security policies and procedures, and training employees on security best practices. Organizations can also seek to monitor their networks and systems for suspicious activity, such as unauthorized access or data exfiltration; however, this can only be done to a limited extent given the technologies and methods that are now available. In the event that this does not occur, they will be forced to perform “reactive” activities following the conclusion of APT attacks in order to confine the attack, investigate the incident, and recover from the damage. All of this is a “reaction” rather than “proactive” like proposed by the inventions described herein.

At this time, there is nothing known to be in place that will look at what normal network traffic at the packet level should look like for a particular service for a specific company which will then continually monitor that border traffic in a two-armed manner (inside and outside) for a border edge control device (or the like) and either block, alert or redirect for example to a “honey pot” solution or the like should the traffic patterns suddenly be altered in a way that is outside of the normal parameters in say a scenario where a service on the border device is being compromised.

Although there are some limited solutions that attempt to address one or more of the foregoing, but only within expensive, complex, and intelligent devices internal “inside” a network, there is no solution that detects and analyzes data/traffic/traffic patterns, etc. on border control/edge devices to look for mismatches or other indicia indicating potential security threats or breaches. This is simply because those devices do not have the software or processing capability to handle this type of computational analysis let alone sophisticated and comprehensive AI/ML capabilities such as, for example, on phones, tablets, printers, border devices, IoT devices, or even more sophisticated machines and datastores without sufficient safeguards.

Hence there is a long felt and unsatisfied need to provide enhanced Al-based information-security for border endpoints to block zero-day APT attacks.

### SUMMARY OF THE INVENTION

In accordance with one or more arrangements of the non-limiting sample disclosures contained herein, solutions are provided to address one or more of the shortcomings in the field of information security by, inter alia: analyzing incoming and outgoing traffic patterns, traffic flow, data packets on both sides of border control edge devices or the like; AI filtering of noise generated from massive quantities of legitimate enterprise traffic in order to focus at the border on the suspect traffic; comparing prior vulnerabilities for both sides of edge devices to historical patterns to detect potential threats; detecting traffic anomalies based on activity on both sides of edge devices; detecting traffic destined only for the firewall and not for anything further in the network; detecting traffic originating from the firewall without any corresponding incoming traffic; providing feedback to an AI engine based on supervised or semi-supervised review of data quantitatively determined based on traffic on both sides of an edge device; quarantining suspect traffic at a border endpoint zero-day block and releasing traffic if determined to be authentic; preemptive blocking of suspicious traffic prior to public or vendor knowledge of software or system vulnerability based on activity on both sides of a border control device; route tracing of suspect traffic back to APT actors from a border control device; in-line zero-day blocking based on in parallel traffic and traffic pattern analysis on both sides of border devices; analysis of packets, traffic, and traffic patterns before reaching a border control device; recognizing that a firewall is compromised if packets are terminated at the firewall and are not destined for anything beyond than the firewall; detection of traffic coming into a firewall and nothing going out; anomalous traffic initiating from the firewall into the network with nothing coming into the firewall from an external source; alerting and correlating suspicious traffic; determining whether there is a correlation between traffic flowing to firewall and traffic leaving the firewall, etc.; tracing APTs and providing alerts/notifications regarding the same; deploying countermeasures to APTs; searching and destroying stashed data generated by the APT and being held for bulk transfer without warning, etc. These are but a few of the various aspects of information-security solutions contained herein to address border endpoint zero-day blocking of APT threats.

Considering the foregoing, the following presents a simplified summary of the present disclosure to provide a basic understanding of various aspects of the disclosure. This summary is not limiting with respect to the exemplary aspects of the inventions described herein and is not an extensive overview of the disclosure. It is not intended to identify key or critical elements of or steps in the disclosure or to delineate the scope of the disclosure. Instead, as would be understood by a personal of ordinary skill in the art, the following summary merely presents some concepts of the disclosure in a simplified form as a prelude to the more detailed description provided below. Moreover, sufficient written descriptions of the inventions are disclosed in the specification throughout this application along with exemplary, non-exhaustive, and non-limiting manners and processes of making and using the inventions, in such full, clear, concise, and exact terms to enable skilled artisans to make and use the inventions without undue experimentation and sets forth the best mode contemplated for carrying out the inventions.

In certain configurations, a solution could either sit in front of a border device such as a firewall or routing device in promiscuous mode, merely grabbing content off the wire, or it could pull packet information directly from the border device and send it to the AI engine for analysis. This would depend on the configuration. The AI engine would then be able to compare the traffic on the network to what it had determined to be normal patterns of traffic, and it would issue an alert for anything that it believed might be an attempt to circumvent a control. This solution would have the capability to block all traffic that was destined for other systems, or it would be able to let traffic pass while retaining information in a database about anything potentially harmful that the traffic passed on (e.g., a potential exploit for a web server behind the border firewall should be stopped by other systems, although this traffic could be destined for a web server but also crafted to exploit the border device as it processed and passed said traffic). The findings could be reported by the solution to a centralized console for evaluation, after which customized settings could be put into place to say that certain traffic should be allowed to pass, blocked, redirected as was previously indicated, or alerted on.

Additionally, settings could be provided by a company building APT solutions in the form of an update or configuration file. This is similar to the way that antivirus software provides DAT files for updates to the antivirus definitions. The solution could analyze normal traffic to and from the device in a lab environment. If it were placed directly inline, the solution would also have the capability of either utilizing known issues, based on the traffic that was permitted to pass through the border device, or it would be able to start a learning process by looking at the traffic and determining what is normal and what is not based on standards for the protocols that are being used on the border device. Both of these options would be available if it were placed directly inline.

During the course of any training period, the alerting/admin console may make it possible for a control team to make minor adjustments to the solution(s). If a pre-production training period was not desired, and instead a deployment was placed and the process was learned as it was implemented, this would work just as well.

A number of aspects of this disclosure provide a way for businesses or any other entity to identify and block or reroute traffic that is of a malicious nature to border systems that are vulnerable to zero-day exploits from APT actors reversing the operating systems on these devices, which allow them to bypass any control system that would identify them. In addition, this disclosure also provides a way for companies to identify and block or reroute traffic that contains sensitive information.

Border devices are able to perform an analysis or a learning process by looking at traffic in order to determine what kind of behavior is normal and what kind of behavior is abnormal based on the protocols that are currently being used on the border device. During the course of any training period, the alerting/admin console may make it possible for a control team to make minor adjustments to the solution(s).

In some arrangements, an information-security, border-endpoint process to block a zero-day threat can comprise the steps of: mirroring, by a network monitor to an artificial intelligence (AI) analyzer (which may include ML or the like), external-outbound traffic and external-inbound traffic on an unprotected side of a network border control device, and internal-outbound traffic and internal-inbound traffic on a protected side of the network border control device; comparing, by the AI analyzer, the external-outbound traffic to the internal-outbound traffic and the external-inbound traffic to the internal-inbound traffic; detecting, by an artificial intelligence (AI) analyzer, suspect traffic if: the external-outbound traffic does not correlate to the internal-outbound traffic, the external-inbound traffic does not correlate to the internal-inbound traffic, the external-inbound traffic does not have a destination beyond the network border control device, the external-outbound traffic, the external-inbound traffic, the internal-outbound traffic, or the internal-inbound traffic match a historical suspect traffic pattern, the external-outbound traffic, the external-inbound traffic, the internal-outbound traffic, or the internal-inbound traffic appears unsolicited, a pattern of traffic for the external-outbound traffic, the external-inbound traffic, the internal-outbound traffic, or the internal-inbound traffic appears anomalous, and any payload in the the external-outbound traffic, the external-inbound traffic, the internal-outbound traffic, or the internal-inbound traffic contains malware or unauthorized data.

In addition, the process may include steps such as: supervising, by an endpoint supervisory server, the AI analyzer; quarantining, by the endpoint supervisory server at a border endpoint zero-day block, the suspect traffic; determining, by the endpoint supervisory server, whether the suspect traffic is an advanced persistent threat (APT); releasing, by the endpoint supervisory server through the border endpoint zero-day block, the suspect traffic if the suspect traffic is not said APT; blocking, by the endpoint supervisory server at the border endpoint zero-day block, the suspect traffic if the suspect traffic is said APT; tracing, by the endpoint supervisory server, the suspect traffic to identify source information regarding the APT; updating, by the endpoint supervisory server, the AI analyzer based on the source information regarding the APT; disabling, by the endpoint supervisory server based the suspect traffic, any said network border control device that was compromised by the APT; updating, by the endpoint supervisory server based on the suspect traffic, security measures in said network border control device to account for the source information for the APT; searching, said network border control device by the endpoint supervisory server, to identify any vulnerabilities storing captured data acquired by the APT; deleting, by the endpoint supervisor server in said network border control device, any said captured data stored based on the vulnerabilities so that the captured data cannot be removed from the APT from the network border control device; updating, by the endpoint supervisory server, the AI analyzer to provide enhanced protection against the APT when the zero-day threat becomes known; and generating, by the endpoint supervisory server to a developer of the software, a notification regarding the vulnerabilities in order resolve said zero-day threat.

In some arrangements, a real-time, partially-real-time, or asynchronous information-security border-endpoint process to block a zero-day threat can comprise steps such as: mirroring, by a network monitor to an artificial intelligence (AI) analyzer, external-outbound traffic and external-inbound traffic on an unprotected side of a firewall and internal-outbound traffic and internal-inbound traffic on a protected side of the firewall; comparing, by the AI analyzer, the external-outbound traffic to the internal-outbound traffic and the external-inbound traffic to the internal-inbound traffic; detecting, by a semi-supervised artificial intelligence (AI) analyzer, suspect traffic if: the external-outbound traffic does not correlate to the internal-outbound traffic, the external-inbound traffic does not correlate to the internal-inbound traffic, the external-inbound traffic does not have a destination beyond the network border control device, the external-outbound traffic, the external-inbound traffic, the internal-outbound traffic, or the internal-inbound traffic match a historical suspect traffic pattern, the external-outbound traffic, the external-inbound traffic, the internal-outbound traffic, or the internal-inbound traffic appears unsolicited, a pattern of traffic for the external-outbound traffic, the external-inbound traffic, the internal-outbound traffic, or the internal-inbound traffic appears anomalous, and any payload in the the external-outbound traffic, the external-inbound traffic, the internal-outbound traffic, or the internal-inbound traffic contains malware or unauthorized data.

Additional steps may be performed such as: supervising, by an endpoint supervisory server, the AI analyzer; quarantining, by the endpoint supervisory server at a border endpoint zero-day block, the suspect traffic; determining, by the endpoint supervisory server, whether the suspect traffic is an advanced persistent threat (APT); releasing, by the endpoint supervisory server through the border endpoint zero-day block, the suspect traffic if the suspect traffic is not said APT; blocking, by the endpoint supervisory server at the border endpoint zero-day block, the suspect traffic if the suspect traffic is said APT; tracing, by the endpoint supervisory server, the suspect traffic to identify source information regarding the APT; deploying, by the endpoint supervisory server, countermeasures to block the suspect traffic based on the identified source information regarding the APT; updating, by the endpoint supervisory server, the AI analyzer based on the source information regarding the APT; disabling, by the endpoint supervisory server based the suspect traffic, any said firewall that was compromised by the APT; updating, by the endpoint supervisory server based on the suspect traffic, security measures in said firewall to account for the source information for the APT; searching, said firewall by the endpoint supervisory server, to identify any vulnerabilities storing captured data acquired by the APT; deleting, by the endpoint supervisor server in said firewall, any said captured data stored based on the vulnerabilities so that the captured data cannot be removed from the APT from the firewall; updating, by the endpoint supervisory server, the Al analyzer to provide enhanced protection against the APT when the zero-day threat becomes known; and generating, by the endpoint supervisory server to a developer of the software, a notification regarding the vulnerabilities in order resolve said zero-day threat.

In some arrangements, one or more various steps or processes disclosed herein can be implemented in whole or in part as computer-executable instructions (or as computer modules or in other computer constructs) stored on computer-readable media. Functionality and steps can be combined into a single machine/engine/system or distributed.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF DRAWINGS

FIG. 1 depicts a sample functional, flow and architectural diagram illustrating sample interactions, interfaces, steps, functions, and components in accordance with one or more information-security aspects of this disclosure as they relate to providing Al-based border-endpoint zero-day blocking of APT threats.

FIG. 2 depicts another sample functional, flow and architectural diagram illustrating sample interactions, interfaces, steps, functions, and components in accordance with one or more information-security aspects of this disclosure as they relate to providing Al-based border-endpoint zero-day blocking of APT threats.

FIG. 3 shows an enhanced sample view of the monitoring, detection, mitigation, blocking, learning, tracing, etc. mechanisms of various configurations such as in FIGS. 1 and 2.

FIG. 4 shows a sample, functional, flow diagram illustrating sample interactions, interfaces, steps, and functions in accordance with one or more information-security aspects of this disclosure as they relate to providing Al-based border-endpoint zero-day blocking of APT threats.

FIG. 5 shows another sample, functional, flow diagram illustrating sample interactions, interfaces, steps, and functions in accordance with one or more information-security aspects of this disclosure as they relate to providing Al-based border-endpoint zero-day blocking of APT threats.

### DETAILED DESCRIPTION

In the following description of the various embodiments to accomplish the foregoing, reference is made to the accompanying drawings, which form a part hereof, and in which is shown by way of illustration, various embodiments in which the disclosure may be practiced. It is to be understood that other embodiments may be utilized, and structural and functional modifications may be made. It is noted that various connections between elements are discussed in the following description. It is noted that these connections are general and, unless specified otherwise, may be direct or indirect, wired, or wireless, and that the specification is not intended to be limiting in this respect.

As used throughout this disclosure, any number of computers, machines, or the like can include one or more general-purpose, customized, configured, special-purpose, virtual, physical, and/or network-accessible devices such as: administrative computers, application servers, clients, cloud devices, clusters, compliance watchers, computing devices, computing platforms, controlled computers, controlling computers, desktop computers, distributed systems, enterprise computers, instances, laptop devices, monitors or monitoring systems, nodes, notebook computers, personal computers, portable electronic devices, portals (internal or external), servers, smart devices, streaming servers, tablets, web servers, and/or workstations, which may have one or more application specific integrated circuits (ASICs), microprocessors, cores, executors etc. for executing, accessing, controlling, implementing etc. various software, computer-executable instructions, data, modules, processes, routines, or the like as discussed below.

References to computers, machines, or the like as in the examples above are used interchangeably in this specification and are not considered limiting or exclusive to any type(s) of electrical device(s), or component(s), or the like. Instead, references in this disclosure to computers, machines, or the like are to be interpreted broadly as understood by skilled artisans. Further, as used in this specification, computers, machines, or the like also include all hardware and components typically contained therein such as, for example, ASICs, processors, executors, cores, etc., display(s) and/or input interfaces/devices, network interfaces, communication buses, or the like, and memories or the like, which can include various sectors, locations, structures, or other electrical elements or components, software, computer-executable instructions, data, modules, processes, routines etc. Other specific or general components, machines, or the like are not depicted in the interest of brevity and would be understood readily by a person of skill in the art.

As used throughout this disclosure, software, computer-executable instructions, data, modules, processes, routines, or the like can include one or more: active-learning, algorithms, alarms, alerts, applications, application program interfaces (APIs), artificial intelligence, approvals, asymmetric encryption (including public/private keys), attachments, big data, CRON functionality, daemons, databases, datasets, datastores, drivers, data structures, emails, extraction functionality, file systems or distributed file systems, firmware, governance rules, graphical user interfaces (GUI or UI), images, instructions, interactions, Java jar files, Java Virtual Machines (JVMs), juggler schedulers and supervisors, load balancers, load functionality, machine learning (supervised, semi-supervised, unsupervised, or natural language processing), middleware, modules, namespaces, objects, operating systems, platforms, processes, protocols, programs, rejections, routes, routines, security, scripts, tables, tools, transactions, transformation functionality, user actions, user interface codes, utilities, web application firewalls (WAFs), web servers, web sites, etc.

The foregoing software, computer-executable instructions, data, modules, processes, routines, or the like can be on tangible computer-readable memory (local, in network-attached storage, be directly and/or indirectly accessible by network, removable, remote, cloud-based, cloud-accessible, etc.), can be stored in volatile or non-volatile memory, and can operate autonomously, on-demand, on a schedule, spontaneously, proactively, and/or reactively, and can be stored together or distributed across computers, machines, or the like including memory and other components thereof. Some or all the foregoing may additionally and/or alternatively be stored similarly and/or in a distributed manner in the network accessible storage/distributed data/datastores/databases/big data etc.

As used throughout this disclosure, computer “networks,” topologies, or the like can include one or more local area networks (LANs), wide area networks (WANs), the Internet, clouds, wired networks, wireless networks, digital subscriber line (DSL) networks, frame relay networks, asynchronous transfer mode (ATM) networks, virtual private networks (VPN), or any direct or indirect combinations of the same. They may also have separate interfaces for internal network communications, external network communications, and management communications. Virtual IP addresses (VIPs) may be coupled to each if desired. Networks also include associated equipment and components such as access points, adapters, buses, ethernet adaptors (physical and wireless), firewalls, hubs, modems, routers, and/or switches located inside the network, on its periphery, and/or elsewhere, and software, computer-executable instructions, data, modules, processes, routines, or the like executing on the foregoing. Network(s) may utilize any transport that supports HTTPS or any other type of suitable communication, transmission, and/or other packet-based protocol.

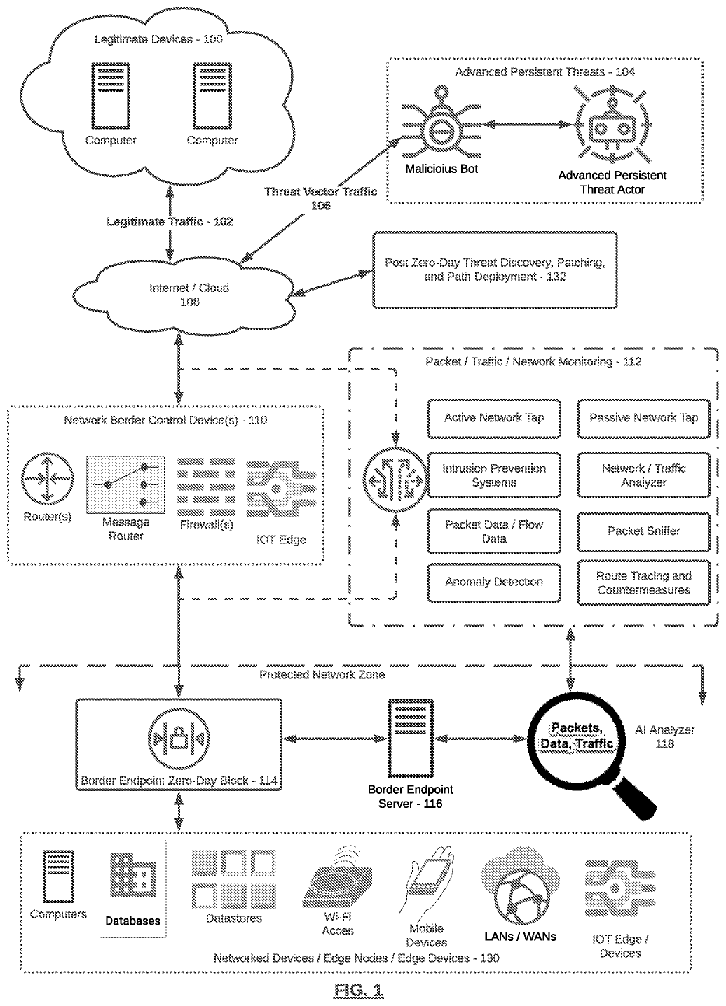

By way of non-limiting disclosure, FIG. 1 depicts a sample functional, flow and architectural diagram illustrating sample interactions, interfaces, steps, functions, and components in accordance with one or more information-security aspects of this disclosure as they relate to providing Al-based border-endpoint zero-day blocking of APT threats.

Legitimate devices 100 provide legitimate traffic 102 over Internet/cloud 108 to legitimate companies and networks. APT actors may use malicious bots or any other nefarious tools to generate advanced persistent threats 104 that similarly transmit threat vector traffic 106 that blends with the legitimate traffic 102 in Internet/cloud 108 and can present an overwhelming amount of data, traffic, and information to network border control devices 110 destined for the legitimate company, its network, or the like. Legitimate traffic can actually be considered noise in the context of the security aspect of this disclosure because it is preferably separated out so that potentially suspect traffic can be focused on and analyzed.

Network border control devices or network edge devices or the like 110 may include routers, message routers, firewalls, IoT edges or IoT edge devices, VPN gateways, switches, combination devices, etc. Data, data flow, packets, payloads, traffic, traffic patterns, etc. may be monitored by network monitor 112 (and may include AI and/or ML functionality), a network monitoring process, a combination device etc. This may include one or more of active network taps, passive network taps, intrusion prevention or detection systems, packet data/flow data analyzers, packet sniffers, network/traffic analyzers, anomaly detectors, route tracers, countermeasure capabilities, etc. Any one or more of the foregoing can be used and can be implemented individually or integrated into a single machine/system/device. They may also be distributed or have distributed functionality if desired. The foregoing devices or functionality can be used to create copies of network traffic, etc. for monitoring or analysis purposes. They can be implemented to gather information on both sides of the network border control device.

The monitoring etc. activity 112 will monitor traffic on both sides of the network border control device(s) 110 that define the edge of the network such as what is within a protected network zone as opposed to what is in the unprotected zone such as on the Internet or cloud side of the device 110.

The packet/traffic/network monitor 112 can be coupled to an AI analyzer 118. This analyzer may filter out noise (i.e. known legitimate data, packets, payloads, traffic, traffic patterns, etc.) and then analyze the remainder based on artificial intelligence, supervised/semi-supervised/unsupervised machine learning in order to identify suspect traffic or focus on the targeted APT activity.

The AI analyzer can identify suspect traffic based on a variety of factors related to the data, data payload, packets, packet contents, traffic, and traffic patterns not only when analyzing them in isolation, but also when comparing what is currently happening against previously Al-compiled data, packets, traffic, patterns, etc. The Al analyzer can detect if the external-outbound traffic does not correlate to the internal-outbound traffic; if the external-inbound traffic does not correlate to the internal-inbound traffic; if the external-inbound traffic does not have a destination beyond the network border control device; if the external-outbound traffic, the external-inbound traffic, the internal-outbound traffic, or the internal-inbound traffic match a historical suspect traffic pattern; if the external-outbound traffic, the external-inbound traffic, the internal-outbound traffic, or the internal-inbound traffic appears unsolicited; if a pattern of traffic for the external-outbound traffic, the external-inbound traffic, the internal-outbound traffic, or the internal-inbound traffic appears anomalous; and/or whether any payload in the the external-outbound traffic, the external-inbound traffic, the internal-outbound traffic, or the internal-inbound traffic contains malware, unauthorized data, etc. For clarity, the foregoing references to external refer to Internet or cloud-side activities on the unprotected side of the network border control devices 110 or the like. Similarly, the references to internal refer to the protected side of the network border control devices 110 or the like.

The border endpoint server 115, AI analyzer 118, and packet/traffic/network monitor 112 can be separate devices or combined with one another as desired to provide the information security functionality. The border endpoint server 116 can control or provide supervision/semi-supervision of AI analyzer 118 as desired. The server may also provide monitoring services and generate internal/external notifications or reports as desired. A border endpoint zero-day block 114 may be controlled by the border endpoint server 116 or the AI analyzer 118. When an APT or suspect traffic is detected, the border endpoint zero-day block may take action to mitigate the threat. This may mean blocking the suspect traffic, closing ports, rerouting traffic or data, disabling devices, taking devices offline, shutting down devices, shutting down network services or access to data, implementing quarantines, searching/destroying data stashed by an APT for later bulk transfer, etc. It may also mean doing any of the foregoing on network border control devices and/or on networked devices/edge nodes/edge devices 130. Post zero-day threat discovery, patching of identified security risks, and deployment paths may be discovered, accessed, and utilized 132 in isolation or cooperatively with software suppliers to correct their vulnerabilities and track APT actors and malicious activity.

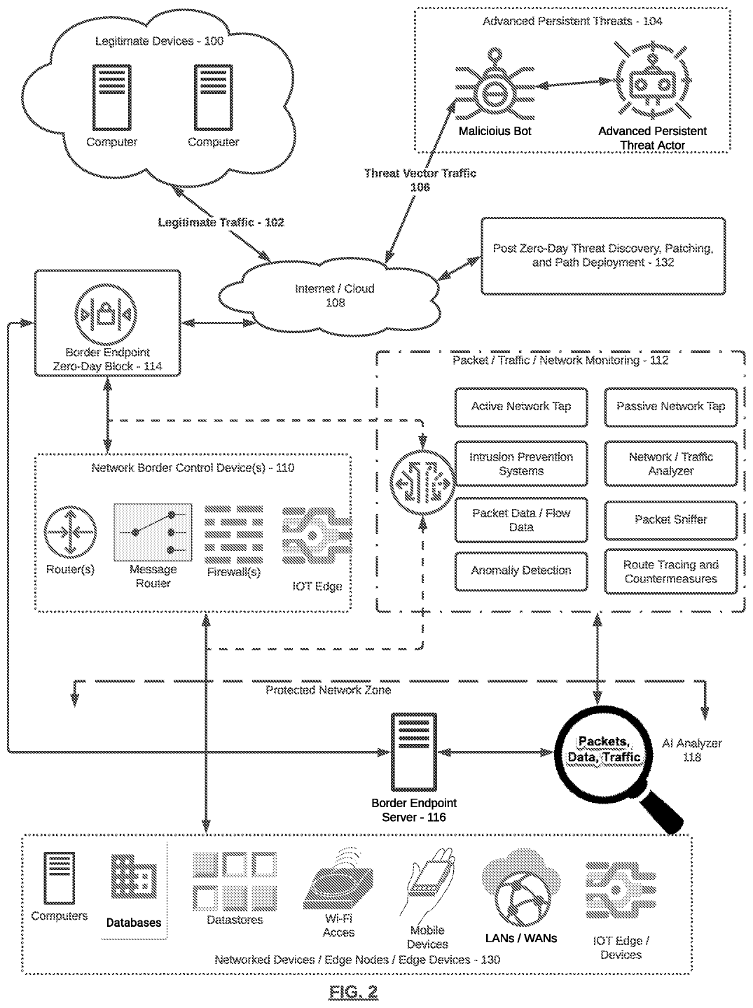

By way of non-limiting disclosure, FIG. 2 depicts another sample functional, flow and architectural diagram illustrating sample interactions, interfaces, steps, functions, and components in accordance with one or more information-security aspects of this disclosure as they relate to providing Al-based border-endpoint zero-day blocking of APT threats. In this configuration, which is similar to FIG. 1, the border endpoint zero-day block 114 may be located on the unprotected side of network border control devices 110. However, the block 114 may still be controlled directly or indirectly by the border endpoint server 116, the AI analyzer 118, or the like, etc.

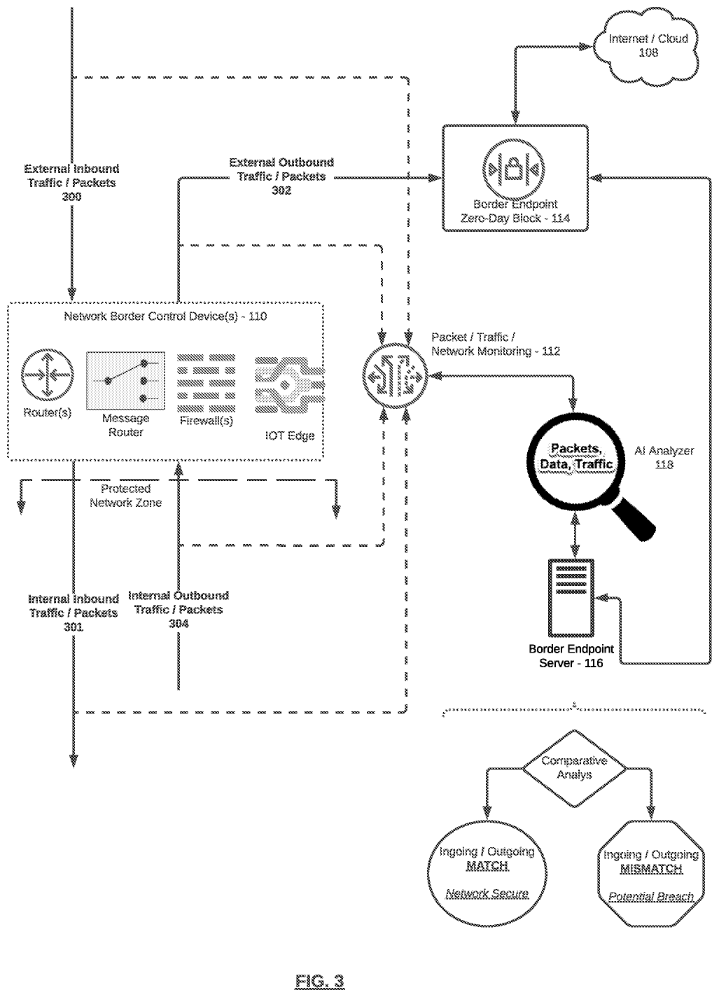

By way of non-limiting disclosure, FIG. 3 shows an enhanced sample view of the monitoring, detection, mitigation, blocking, learning, tracing, etc. mechanisms of various configurations such as in FIGS. 1 and 2.

External traffic/packets 300 may arrive in bound to network border control devices 110 from Internet/cloud 108 or elsewhere. If allowed, the traffic/packets may then proceed through devices 110 into the protected network zone as internal inbound traffic/packets 301.

Similarly, traffic and packets generated in the protected network zone may be sent as internal outbound traffic/packets 304 through the network border control devices 110 and, if passed, become external outbound traffic/packets 302.

The four depicted sets of traffic/packets (i.e., external inbound 300, internal inbound 301, external outbound 302, and internal inbound 304) can be monitored on a data, payload, packet, traffic, and/or pattern basis, which can be analyzed by AI analyzer 118 and border endpoint server 116, as previously discussed, and can then be used to control border endpoint zero-day block 114. Sample comparative analysis is shown for illustration purposes with respect to traffic on one side of the network edge as opposed to on the other side of the edge. As one example, if incoming and outgoing traffic match or correlate as expected, the traffic may be legitimate, and the network may be secure. Conversely, if there is a mismatch, imbalance, or other issue, there may be a potential breach.

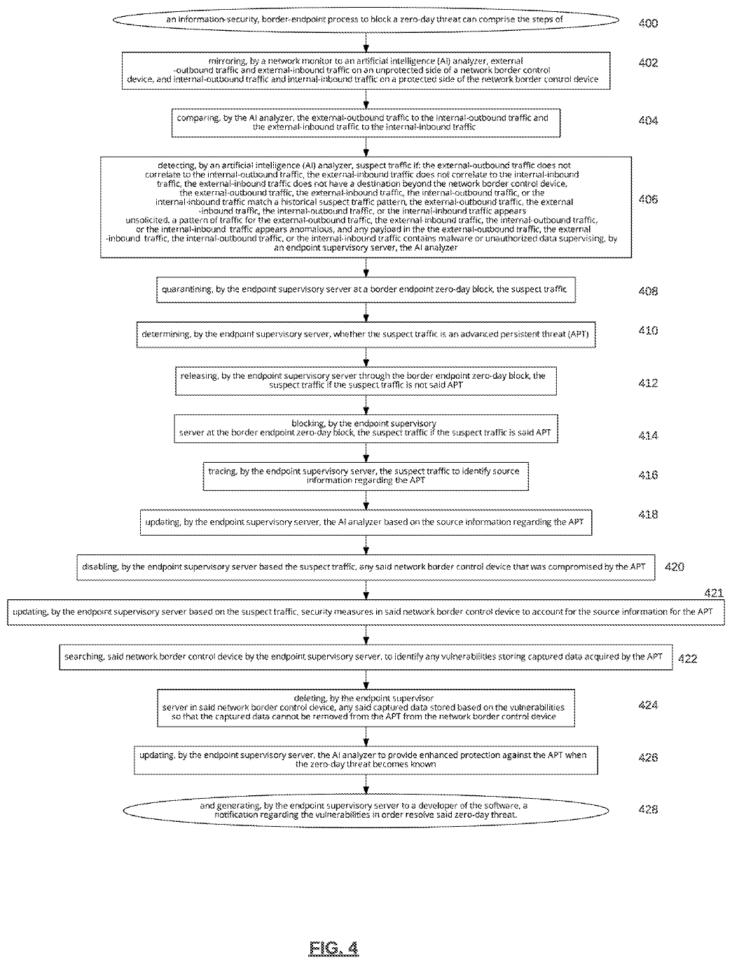

By way of non-limiting disclosure, FIG. 4 shows a sample, functional, flow diagram illustrating sample interactions, interfaces, steps, and functions in accordance with one or more information-security aspects of this disclosure as they relate to providing Al-based border-endpoint zero-day blocking of APT threats.

In this example, an information-security, border-endpoint process to block a zero-day threat 400 can comprise one or more various steps, such as, mirroring, by a network monitor to an artificial intelligence (AI) analyzer, external-outbound traffic and external-inbound traffic on an unprotected side of a network border control device, and internal-outbound traffic and internal-inbound traffic on a protected side of the network border control device in 402. In 404, comparing, by the AI analyzer, the external-outbound traffic to the internal-outbound traffic and the external-inbound traffic to the internal-inbound traffic can be performed.

In 406, detecting, by an artificial intelligence (AI) analyzer, suspect traffic can be identified if, for example: the external-outbound traffic does not correlate to the internal-outbound traffic, the external-inbound traffic does not correlate to the internal-inbound traffic, the external-inbound traffic does not have a destination beyond the network border control device, the external-outbound traffic, the external-inbound traffic, the internal-outbound traffic, or the internal-inbound traffic match a historical suspect traffic pattern, the external-outbound traffic, the external-inbound traffic, the internal-outbound traffic, or the internal-inbound traffic appears unsolicited, a pattern of traffic for the external-outbound traffic, the external-inbound traffic, the internal-outbound traffic, or the internal-inbound traffic appears anomalous, and any payload in the the external-outbound traffic, the external-inbound traffic, the internal-outbound traffic, or the internal-inbound traffic contains malware or unauthorized data.

In addition, the process may include steps such as: supervising, by an endpoint supervisory server, the AI analyzer. In 408 and 410, quarantining, by the endpoint supervisory server at a border endpoint zero-day block, the suspect traffic, and determining, by the endpoint supervisory server, whether the suspect traffic is an advanced persistent threat (APT) can be performed.

In 412, 414, and 416 steps of releasing, by the endpoint supervisory server through the border endpoint zero-day block, the suspect traffic if the suspect traffic is not said APT; blocking, by the endpoint supervisory server at the border endpoint zero-day block, the suspect traffic if the suspect traffic is said APT; tracing, by the endpoint supervisory server, the suspect traffic to identify source information regarding the APT are implemented.

Additional steps of updating, by the endpoint supervisory server, the AI analyzer based on the source information regarding the APT (418); disabling, by the endpoint supervisory server based the suspect traffic, any said network border control device that was compromised by the APT (420); updating, by the endpoint supervisory server based on the suspect traffic, security measures in said network border control device to account for the source information for the APT (421); searching, said network border control device by the endpoint supervisory server, to identify any vulnerabilities storing captured data acquired by the APT (422); deleting, by the endpoint supervisor server in said network border control device, any said captured data stored based on the vulnerabilities so that the captured data cannot be removed from the APT from the network border control device (424); updating, by the endpoint supervisory server, the AI analyzer to provide enhanced protection against the APT when the zero-day threat becomes known (426); and generating, by the endpoint supervisory server to a developer of the software, a notification regarding the vulnerabilities in order resolve said zero-day threat (428) can be executed.

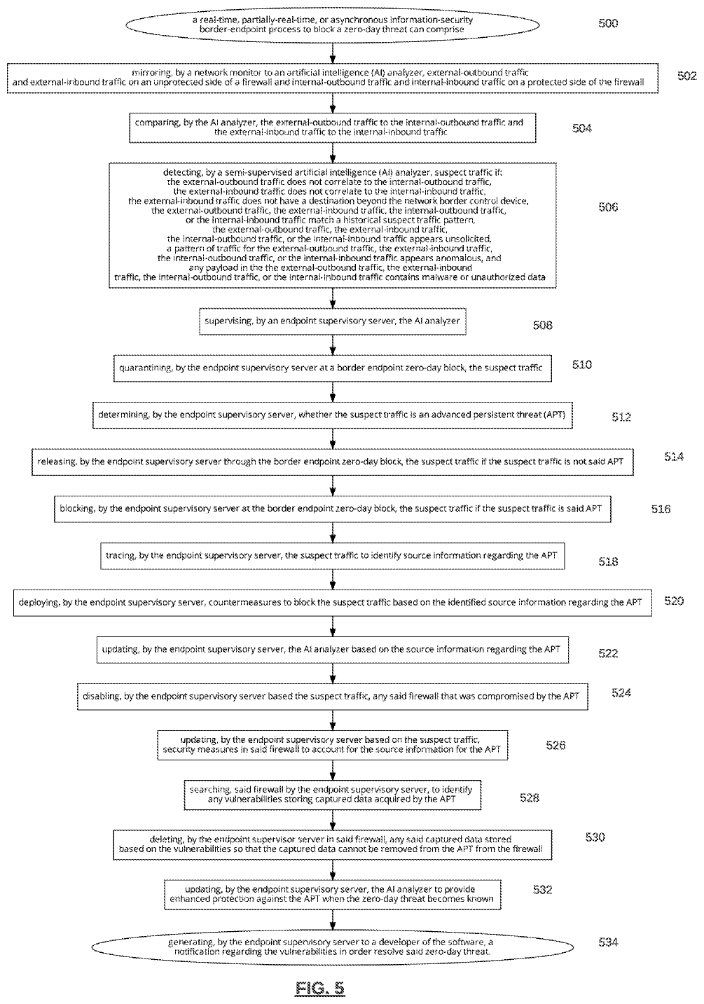

By way of non-limiting disclosure, FIG. 5 shows another sample, functional, flow diagram illustrating sample interactions, interfaces, steps, and functions in accordance with one or more information-security aspects of this disclosure as they relate to providing Al-based border-endpoint zero-day blocking of APT threats.

In some configurations, a real-time, partially-real-time, or asynchronous information-security border-endpoint process to block a zero-day threat (500) can comprise steps such as: mirroring, by a network monitor to an artificial intelligence (AI) analyzer, external-outbound traffic and external-inbound traffic on an unprotected side of a firewall and internal-outbound traffic and internal-inbound traffic on a protected side of the firewall (502); comparing, by the AI analyzer, the external-outbound traffic to the internal-outbound traffic and the external-inbound traffic to the internal-inbound traffic (504); detecting, by a semi-supervised artificial intelligence (AI) analyzer, suspect traffic if: the external-outbound traffic does not correlate to the internal-outbound traffic, the external-inbound traffic does not correlate to the internal-inbound traffic, the external-inbound traffic does not have a destination beyond the network border control device, the external-outbound traffic, the external-inbound traffic, the internal-outbound traffic, or the internal-inbound traffic match a historical suspect traffic pattern, the external-outbound traffic, the external-inbound traffic, the internal-outbound traffic, or the internal-inbound traffic appears unsolicited, a pattern of traffic for the external-outbound traffic, the external-inbound traffic, the internal-outbound traffic, or the internal-inbound traffic appears anomalous, and any payload in the the external-outbound traffic, the external-inbound traffic, the internal-outbound traffic, or the internal-inbound traffic contains malware or unauthorized data (506).

Additional steps may be performed such as: supervising, by an endpoint supervisory server, the AI analyzer (508); quarantining, by the endpoint supervisory server at a border endpoint zero-day block, the suspect traffic (510); determining, by the endpoint supervisory server, whether the suspect traffic is an advanced persistent threat (APT) (512); releasing, by the endpoint supervisory server through the border endpoint zero-day block, the suspect traffic if the suspect traffic is not said APT (514); blocking, by the endpoint supervisory server at the border endpoint zero-day block, the suspect traffic if the suspect traffic is said APT (516); tracing, by the endpoint supervisory server, the suspect traffic to identify source information regarding the APT (518); deploying, by the endpoint supervisory server, countermeasures to block the suspect traffic based on the identified source information regarding the APT (520); updating, by the endpoint supervisory server, the AI analyzer based on the source information regarding the APT (522); disabling, by the endpoint supervisory server based the suspect traffic, any said firewall that was compromised by the APT (524); updating, by the endpoint supervisory server based on the suspect traffic, security measures in said firewall to account for the source information for the APT (526); searching, said firewall by the endpoint supervisory server, to identify any vulnerabilities storing captured data acquired by the APT (528); deleting, by the endpoint supervisor server in said firewall, any said captured data stored based on the vulnerabilities so that the captured data cannot be removed from the APT from the firewall (530); updating, by the endpoint supervisory server, the AI analyzer to provide enhanced protection against the APT when the zero-day threat becomes known (532); and generating, by the endpoint supervisory server to a developer of the software, a notification regarding the vulnerabilities in order resolve said zero-day threat (534).

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. An information-security, border-endpoint process to block a zero-day threat comprising the steps of:
mirroring, by a network monitor to an artificial intelligence (AI) analyzer, external-outbound traffic and external-inbound traffic on an unprotected side of a network border control device, and internal-outbound traffic and internal-inbound traffic on a protected side of the network border control device;
comparing, by the AI analyzer, the external-outbound traffic to the internal-outbound traffic and the external-inbound traffic to the internal-inbound traffic;
detecting, by an artificial intelligence (AI) analyzer, suspect traffic if:
the external-outbound traffic does not correlate to the internal-outbound traffic,
the external-inbound traffic does not correlate to the internal-inbound traffic,
the external-inbound traffic does not have a destination beyond the network border control device,
the external-outbound traffic, the external-inbound traffic, the internal-outbound traffic, or the internal-inbound traffic match a historical suspect traffic pattern,
the external-outbound traffic, the external-inbound traffic, the internal-outbound traffic, or the internal-inbound traffic appears unsolicited,
a pattern of traffic for the external-outbound traffic, the external-inbound traffic, the internal-outbound traffic, or the internal-inbound traffic appears anomalous, and
any payload in the the external-outbound traffic, the external-inbound traffic, the internal-outbound traffic, or the internal-inbound traffic contains malware or unauthorized data;
supervising, by an endpoint supervisory server, the AI analyzer;
quarantining, by the endpoint supervisory server at a border endpoint zero-day block, the suspect traffic;
determining, by the endpoint supervisory server, whether the suspect traffic is an advanced persistent threat (APT);
releasing, by the endpoint supervisory server through the border endpoint zero-day block, the suspect traffic if the suspect traffic is not said APT;
blocking, by the endpoint supervisory server at the border endpoint zero-day block, the suspect traffic if the suspect traffic is said APT;
tracing, by the endpoint supervisory server, the suspect traffic to identify source information regarding the APT;
updating, by the endpoint supervisory server, the AI analyzer based on the source information regarding the APT;
disabling, by the endpoint supervisory server based the suspect traffic, any said network border control device that was compromised by the APT;
updating, by the endpoint supervisory server based on the suspect traffic, security measures in said network border control device to account for the source information for the APT;
searching, said network border control device by the endpoint supervisory server, to identify any vulnerabilities storing captured data acquired by the APT;
deleting, by the endpoint supervisor server in said network border control device, any said captured data stored based on the vulnerabilities so that the captured data cannot be removed from the APT from the network border control device;
updating, by the endpoint supervisory server, the AI analyzer to provide enhanced protection against the APT when the zero-day threat becomes known; and
generating, by the endpoint supervisory server to a developer of the software, a notification regarding the vulnerabilities in order resolve said zero-day threat.

2. The process of claim 1 wherein the network border control device of claim 1 is a firewall.

3. The process of claim 1 wherein the network border control device of claim 1 is a router.

4. The process of claim 1 wherein the network border control device of claim 1 is an Internet of Things (IoT) edge device.

5. The process of claim 2 wherein the network monitor is an active network tap.

6. The process of claim 2 wherein the network monitor is a passive network tap.

7. The process of claim 6 wherein the AI analyzer analyzes packet data.

8. The process of claim 6 wherein the AI analyzer analyzes flow data.

9. The process of claim 6 wherein the AI analyzer analyzes packet contents.

10. The process of claim 7 wherein the tracing of the source information analyzes packet headers and routing data to locate the APT.

11. The process of claim 10 further comprising the step of learning, by the AI analyzer, based on the source information for the APT and the suspect traffic confirmed to present said APT.

12. The process of claim 11 wherein the endpoint supervisory server utilizes supervised machine learning to train or maintain the AI analyzer.

13. The process of claim 11 wherein the endpoint supervisory server utilizes semi-supervised machine learning to train or maintain the AI analyzer.

14. The process of claim 12 wherein the border endpoint zero-day block is located outside the protected side of the network border control device.

15. The process of claim 12 wherein the border endpoint zero-day block is located inside the protected side of the network border control device.

16. An information-security border-endpoint process to block a zero-day threat comprising the steps of:
mirroring, by a network monitor to an artificial intelligence (AI) analyzer, external-outbound traffic and external-inbound traffic on an unprotected side of a firewall and internal-outbound traffic and internal-inbound traffic on a protected side of the firewall;
comparing, by the AI analyzer, the external-outbound traffic to the internal-outbound traffic and the external-inbound traffic to the internal-inbound traffic;
detecting, by a semi-supervised artificial intelligence (AI) analyzer, suspect traffic if:
the external-outbound traffic does not correlate to the internal-outbound traffic,
the external-inbound traffic does not correlate to the internal-inbound traffic,
the external-inbound traffic does not have a destination beyond the firewall,
the external-outbound traffic, the external-inbound traffic, the internal-outbound traffic, or the internal-inbound traffic match a historical suspect traffic pattern,
the external-outbound traffic, the external-inbound traffic, the internal-outbound traffic, or the internal-inbound traffic appears unsolicited,
a pattern of traffic for the external-outbound traffic, the external-inbound traffic, the internal-outbound traffic, or the internal-inbound traffic appears anomalous, and
any payload in the the external-outbound traffic, the external-inbound traffic, the internal-outbound traffic, or the internal-inbound traffic contains malware or unauthorized data;
supervising, by an endpoint supervisory server, the AI analyzer;
quarantining, by the endpoint supervisory server at a border endpoint zero-day block, the suspect traffic;
determining, by the endpoint supervisory server, whether the suspect traffic is an advanced persistent threat (APT);
releasing, by the endpoint supervisory server through the border endpoint zero-day block, the suspect traffic if the suspect traffic is not said APT;
blocking, by the endpoint supervisory server at the border endpoint zero-day block, the suspect traffic if the suspect traffic is said APT;
tracing, by the endpoint supervisory server, the suspect traffic to identify source information regarding the APT;
deploying, by the endpoint supervisory server, countermeasures to block the suspect traffic based on the identified source information regarding the APT;
updating, by the endpoint supervisory server, the AI analyzer based on the source information regarding the APT;
disabling, by the endpoint supervisory server based the suspect traffic, any said firewall that was compromised by the APT;
updating, by the endpoint supervisory server based on the suspect traffic, security measures in said firewall to account for the source information for the APT;
searching, said firewall by the endpoint supervisory server, to identify any vulnerabilities storing captured data acquired by the APT;
deleting, by the endpoint supervisor server in said firewall, any said captured data stored based on the vulnerabilities so that the captured data cannot be removed from the APT from the firewall;
updating, by the endpoint supervisory server, the AI analyzer to provide enhanced protection against the APT when the zero-day threat becomes known; and
generating, by the endpoint supervisory server to a developer of the software, a notification regarding the vulnerabilities in order resolve said zero-day threat.

17. The process of claim 16 wherein the firewall is also a router.

18. The process of claim 17 wherein the network monitor is a network tap.

19. The process of claim 18 wherein the network monitor is a network analyzer.

20. A real-time, information-security, border-endpoint process to block a zero-day threat comprising the steps of:
mirroring, by a network monitor to an artificial intelligence (AI) analyzer, external-outbound traffic and external-inbound traffic on an unprotected side of a firewall and internal-outbound traffic and internal-inbound traffic on a protected side of the firewall;
comparing, by the AI analyzer, the external-outbound traffic to the internal-outbound traffic and the external-inbound traffic to the internal-inbound traffic;
detecting, by a semi-supervised artificial intelligence (AI) analyzer, suspect traffic if:
the external-outbound traffic does not correlate to the internal-outbound traffic,
the external-inbound traffic does not correlate to the internal-inbound traffic,
the external-inbound traffic does not have a destination beyond the firewall,
the external-outbound traffic, the external-inbound traffic, the internal-outbound traffic, or the internal-inbound traffic match a historical suspect traffic pattern,
the external-outbound traffic, the external-inbound traffic, the internal-outbound traffic, or the internal-inbound traffic appears unsolicited,
a pattern of traffic for the external-outbound traffic, the external-inbound traffic, the internal-outbound traffic, or the internal-inbound traffic appears anomalous, and
any payload in the the external-outbound traffic, the external-inbound traffic, the internal-outbound traffic, or the internal-inbound traffic contains malware or unauthorized data;
supervising, by an endpoint supervisory server, the AI analyzer;
quarantining, by the endpoint supervisory server at a border endpoint zero-day block, the suspect traffic;
determining, by the endpoint supervisory server, whether the suspect traffic is an advanced persistent threat (APT);
releasing, by the endpoint supervisory server through the border endpoint zero-day block, the suspect traffic if the suspect traffic is not said APT;
blocking, by the endpoint supervisory server at the border endpoint zero-day block, the suspect traffic if the suspect traffic is said APT;
tracing, by the endpoint supervisory server, the suspect traffic to identify source information regarding the APT;
Deploying, by the endpoint supervisory server, countermeasures to block the suspect traffic based on the identified source information regarding the APT;
updating, by the endpoint supervisory server, the AI analyzer based on the source information regarding the APT;
disabling, by the endpoint supervisory server based the suspect traffic, any said firewall that was compromised by the APT;
updating, by the endpoint supervisory server based on the suspect traffic, security measures in said firewall to account for the source information for the APT;
searching, said firewall by the endpoint supervisory server, to identify any vulnerabilities storing captured data acquired by the APT;
deleting, by the endpoint supervisor server in said firewall, any said captured data stored based on the vulnerabilities so that the captured data cannot be removed from the APT from the firewall;
updating, by the endpoint supervisory server, the AI analyzer to provide enhanced protection against the APT when the zero-day threat becomes known; and
generating, by the endpoint supervisory server to a developer of the software, a notification regarding the vulnerabilities in order resolve said zero-day threat.
